(19) United States
(12) Patent Application Publication
(10) Pub. No.: US 2019/0386275 A1
(43) Pub. Date: Dec. 19, 2019

(54) NONAQUEOUS ELECTROLYTE SECONDARY BATTERY POROUS LAYER

(71) Applicant: Sumitomo Chemical Company, Limited, Tokyo (JP)

(72) Inventors: Haruki OTSUKA, Niihama-shi (JP); Chikara MURAKAMI, Niihama-shi (JP)

(21) Appl. No.: 16/441,810

(22) Filed: Jun. 14, 2019

(30) Foreign Application Priority Data
Jun. 15, 2018 (JP) 2018-114933

(51) Int. Cl. H01M 2/16; H01M 10/0525; H01M 10/0585

(52) U.S. Cl. CPC H01M 2/16; H01M 10/0585; H01M 10/0525

(57) ABSTRACT

A nonaqueous electrolyte secondary battery porous layer is provided which contains a filler including a benzendiol-aldehyde resin. The porous layer provides a nonaqueous electrolyte secondary battery with improved long-term cycle characteristics.

This Nonprovisional application claims priority under 35 U.S.C. § 119 on Patent Application No. 2018-114933 filed in Japan on Jun. 15, 2018, the entire contents of which are hereby incorporated by reference.

### TECHNICAL FIELD

The present invention relates to a porous layer for a nonaqueous electrolyte secondary battery (hereinafter referred to as “nonaqueous electrolyte secondary battery porous layer”).

### BACKGROUND ART

Nonaqueous electrolyte secondary batteries, particularly lithium ion secondary batteries, have a high energy density and are therefore in wide use as batteries for personal computers, mobile phones, portable information terminals, and the like. Such nonaqueous electrolyte secondary batteries have recently been developed as on-vehicle batteries.

As a member of such a nonaqueous electrolyte secondary battery, a separator having excellent heat resistance is under development.

Further, development is underway of a porous layer containing a filler as a nonaqueous electrolyte secondary battery porous layer for use in a separator having excellent heat resistance. Patent Literature 1 discloses, as an example of such a porous layer, a nonaqueous electrolyte secondary battery including a separator (porous layer) containing a filler made of an inorganic substance such as alumina. Patent Literature 2 discloses a nonaqueous electrolyte secondary battery including a positive electrode, a negative electrode, and a porous layer between the positive electrode and the negative electrode which porous layer contains (i) resin particles made of an organic substance such as phenol resin and (ii) a binder resin.

### CITATION LIST

### Patent Literature

[Patent Literature 1]

Japanese Patent Application Publication, Tokukai, No. 2009-146822

[Patent Literature 2]

Japanese Patent Application Publication, Tokukai, No. 2015-215987

### SUMMARY OF INVENTION

### Technical Problem

Nonaqueous electrolyte secondary batteries including a conventional separator such as the above, unfortunately, leave room for improvement in terms of long-term cycle characteristic.

### Solution to Problem

The present invention has aspects described in [1] to [5] below.

[1] A nonaqueous electrolyte secondary battery porous layer, including: a filler including a benzendiol-aldehyde resin.

[2] The nonaqueous electrolyte secondary battery porous layer according to [1], wherein: the filler has a content of not less than 60% by weight and not more than 99.5% by weight with respect to a total weight of the nonaqueous electrolyte secondary battery porous layer.

[3] The nonaqueous electrolyte secondary battery porous layer according to [1] or [2], further including: at least one binder resin selected from the group consisting of a polyolefin, a (meth)acrylate-based resin, a fluorine-containing resin, a polyamide-based resin, a polyester-based resin, and a water-soluble polymer.

[4] The nonaqueous electrolyte secondary battery porous layer according to [3], wherein: the polyamide-based resin is aramid resin.

[5] A nonaqueous electrolyte secondary battery laminated separator, including: a polyolefin porous film; and a nonaqueous electrolyte secondary battery porous layer according to any one of [1] to [4], the nonaqueous electrolyte secondary battery porous layer being provided on at least one surface of the polyolefin porous film.

[6] A nonaqueous electrolyte secondary battery member including: a positive electrode; a nonaqueous electrolyte secondary battery porous layer according to any one of [1] to [4] or nonaqueous electrolyte secondary battery laminated separator according to [5]; and a negative electrode, the positive electrode, the nonaqueous electrolyte secondary battery porous layer or nonaqueous electrolyte secondary battery laminated separator, and the negative electrode being arranged in this order.

[7] A nonaqueous electrolyte secondary battery including: a nonaqueous electrolyte secondary battery porous layer according to any one of [1] to [4] or nonaqueous electrolyte secondary battery laminated separator according to [5].

### Advantageous Effects of Invention

A nonaqueous electrolyte secondary battery porous layer in accordance with an embodiment of the present invention advantageously makes it possible to provide a nonaqueous electrolyte secondary battery having an excellent long-term cycle characteristic such as the discharge capacity maintaining ratio after 100 cycles.

### DESCRIPTION OF EMBODIMENTS

The following description will discuss an embodiment of the present invention. The present invention is, however, not limited to such an embodiment. Further, the present invention is not limited to the description of the arrangements below, but may be altered in various ways by a skilled person within the scope of the claims. Any embodiment based on a proper combination of technical means disclosed in different embodiments is also encompassed in the technical scope of the present invention. Any numerical range expressed as “A to B” herein means “not less than A and not more than B” unless otherwise stated.

[Nonaqueous Electrolyte Secondary Battery Porous Layer]

A nonaqueous electrolyte secondary battery porous layer in accordance with an embodiment of the present invention (hereinafter referred to simply as “porous layer” as well) includes a filler including a benzendiol-aldehyde resin.

The filler is a filler including a benzendiol-aldehyde resin. The filler contains a benzendiol-aldehyde resin in an amount of preferably not less than 50% by weight, more preferably not less than 80% by weight, even more preferably not less than 90% by weight, even more preferably not less than 95% by weight, even more preferably not less than 98% by weight, on the basis of the weight of the filler.

The benzendiol-aldehyde resin is a polymer produced through polymerization of a benzendiol-based monomer and an aldehyde-based monomer.

Examples of the benzendiol-based monomer include catechol, resorcin (resorcinol), and hydroquinone. The benzendiol-based monomer is preferably resorcin. A single kind of benzendiol-based monomer or a mixture of two or more kinds of benzendiol-based monomers may be used.

The aldehyde-based monomer may be any aldehyde. Examples of the aldehyde-based monomer include formaldehyde, acetaldehyde, propionaldehyde, benzaldehyde, furfural, and thiophene carboxaldehyde. The aldehyde-based monomer is preferably formaldehyde. A formaldehyde monomer may be prepared from trioxane (which is a trimer of formaldehyde) or paraformaldehyde (which is a multimer of formaldehyde) when polymerized with a benzendiol-based monomer. A single kind of aldehyde-based monomer or a mixture of two or more kinds of aldehyde-based monomers may be used.

The benzendiol-aldehyde resin may be any polymer produced through polymerization of the above benzendiol-based monomer and the above aldehyde-based monomer. The benzendiol-aldehyde resin is preferably a resorcin-formaldehyde resin (RF resin) produced through polymerization of resorcin and formaldehyde. The filler may include a single kind of benzendiol-aldehyde resin or two or more kinds of benzendiol-aldehyde resins.

The benzendiol-aldehyde resin may include a benzendiol-based monomer and an aldehyde-based monomer at any ratio. The benzendiol-aldehyde resin is preferably a polymer produced through polymerization of a benzendiol-based monomer and an aldehyde-based monomer at a molar ratio within a range of 1:0.5 to 1:3.

The benzendiol-aldehyde resin preferably has a three-dimensional crosslinked structure because such an arrangement can prevent the benzendiol-aldehyde resin from (i) being dissolved easily in a nonaqueous electrolyte in the battery and also from (ii) being degraded due to a side reaction such as oxidation while the battery is in use. The benzendiol-aldehyde resin having a three-dimensional crosslinked structure as described in the present specification may be verified as such by the benzendiol-aldehyde resin having a solubility of not more than 10 g with respect to 100 g of a mixed solvent of ethylene carbonate, ethyl methyl carbonate, and diethyl carbonate each having a temperature of 25° C. and mixed at a volume ratio of 3:5:2. A mixed solvent of ethylene carbonate, ethyl methyl carbonate, and diethyl carbonate mixed at a volume ratio of 3:5:2 is generally used as an organic solvent for use in a nonaqueous electrolyte, and has a solubility similarly to that of a typical organic solvent for use in a nonaqueous electrolyte.

A benzendiol-aldehyde resin polymerized with use of a base catalyst will have a three-dimensional crosslinked structure as the benzendiol-aldehyde resin is heated. Such a resin may have a three-dimensional crosslinked structure as the resin is heated in the presence of a curing agent.

Typically, a filler having a hydroxyl group (—OH) as a proton acid is not used in a nonaqueous electrolyte secondary battery porous layer because such a filler may deactivate the positive electrode material or an electrolyte salt and thereby decrease the battery performance. Further, a filler having a hydroxyl group (—OH), regardless of whether the hydroxyl group is a proton acid, has high moisture absorbency, and thus increases the amount of water brought into the battery, which can degrade the long-term cycle characteristic of the battery. A filler having a hydroxyl group (—OH) has not been used as a material of a main component of a nonaqueous electrolyte secondary battery porous layer, and also has constraints such as the constraint that the filler will need sufficient drying before being assembled in a battery. However, a nonaqueous electrolyte secondary battery porous layer in accordance with an embodiment of the present invention, which includes a filler including a benzendiol-aldehyde resin having a hydroxyl group (—OH), allows for an excellent long-term cycle characteristic contrary to the above brief.

A porous layer in accordance with an embodiment of the present invention is disposed, as a member of a nonaqueous electrolyte secondary battery, between (i) a polyolefin porous film and (ii) at least either of a positive electrode and a negative electrode. The porous layer may be formed on at least one surface of the polyolefin porous film. Alternatively, the porous layer may be formed on the active material layer of at least either of the positive electrode and the negative electrode. Further alternatively, the porous layer may be disposed between the polyolefin porous film and at least either of the positive electrode and the negative electrode in such a manner as to be in contact with the polyolefin porous film and the at least either of the positive electrode and the negative electrode. There may be a single porous layer or two or more porous layers between the polyolefin porous film and at least either of the positive electrode and the negative electrode.

In a case where the porous layer is provided on one surface of the polyolefin porous film, the porous layer is preferably provided on that surface of the polyolefin porous film which faces the positive electrode. The porous layer is more preferably provided on that surface of the polyolefin porous film which is in contact with the positive electrode. The porous layer is preferably an insulating porous layer.

The porous layer in accordance with an embodiment of the present invention has a structure in which many pores, connected to one another, are provided, so that the porous layer is a layer through which a gas or a liquid can pass from one surface to the other. Further, in a case where the porous layer in accordance with an embodiment of the present invention is used as a member included in a nonaqueous electrolyte secondary battery laminated separator, the porous layer can be a layer which, serving as an outermost layer of the separator (laminated body), comes into contact with an electrode.

A porous layer in accordance with an embodiment of the present invention may contain a binder resin other than the filler (hereinafter referred to simply as “filler A” as well) including the benzendiol-aldehyde resin. The binder resin can serve as a resin to (i) bind particles of the filler to each other, (ii) bind the filler to the positive electrode or the negative electrode, and/or (iii) bind the filler to the polyolefin porous film.

The binder resin is preferably (i) insoluble in the electrolyte of a nonaqueous electrolyte secondary battery to be produced and (ii) electrochemically stable when the nonaqueous electrolyte secondary battery is in normal use. Examples of the binder resin include polyolefins; (meth)acrylate-based resins; fluorine-containing resins; polyamide-based resins; polyimide-based resins; polyester-based resins; rubbers; resins with a melting point or glass transition temperature of not lower than 180′C; water-soluble polymers; polycarbonate, polyacetal, and polyether ether ketone. Among the above binder resins, polyolefins, (meth)acrylate-based resins, fluorine-containing resins, polyamide-based resins, polyester-based resins, and water-soluble polymers are preferable. Specific examples of the binder resin encompass: polyolefins such as polyethylene, polypropylene, polybutene, and an ethylene-propylene copolymer; fluorine-containing resins such as polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; a fluorine-containing rubber having a glass transition temperature of equal to or less than 23° C., among the fluorine-containing resins; polyamide-based resins such as aramid resins such as aromatic polyamide and wholly aromatic polyamide; rubbers such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins with a melting point or glass transition temperature of not lower than 180° C. such as polyphenylene ether, polysulfone, polyether sulfone, polyphenylene sulfide, polyetherimide, polyamide imide, polyether amide, and polyester; polyester-based resins such as (i) aromatic polyester such as polyarylate and (ii) liquid crystal polyester; and water-soluble polymers such as polyvinyl alcohol, polyethylene glycol, cellulose ether, sodium alginate, polyacrylic acid, polyacrylamide, and polymethacrylic acid.

Alternatively, a water-insoluble polymer can be suitably used as the binder resin contained in the porous layer in accordance with an embodiment of the present invention. In other words, the porous layer in accordance with an embodiment of the present invention, which contains (i) a water-insoluble polymer such as acrylate resin as the binder resin and (ii) the filler, is produced preferably with use of an emulsion obtained by dispersing the water-insoluble polymer in an aqueous solvent.

Note that the water-insoluble polymer means a polymer that does not dissolve in an aqueous solvent but becomes particles so as to be dispersed in an aqueous solvent. “Water-insoluble polymer” means a polymer which has an insoluble content of not less than 90% by weight in a case where 0.5 g of the polymer is mixed with 100 g of water at 25 C. Meanwhile, the “water-soluble polymer” refers to a polymer which has an insoluble content of less than 0.5% by weight in a case where 0.5 g of the polymer is mixed with 100 g of water at 25′C. The shape of the particles of the water-insoluble polymer is not limited to any particular one, but is preferably a spherical shape.

The water-insoluble polymer is produced as polymer particles by, for example, polymerizing, in an aqueous solvent, a monomer composition containing a monomer (described later).

Examples of the monomer included in the water-insoluble polymer encompass styrene, vinyl ketone, acrylonitrile, methyl methacrylate, ethyl methacrylate, glycidyl methacrylate, glycidyl acrylate, methyl acrylate, ethyl acrylate, and butyl acrylate.

The aqueous solvent contains water, and is not limited to any particular one, provided that the water-insoluble polymer particles can be dispersed in the aqueous solvent.

The aqueous solvent can contain an organic solvent which can be dissolved in water at any ratio to the water. Examples of such an organic solvent encompass methanol, ethanol, isopropyl alcohol, acetone, tetrahydrofuran, acetonitrile, and N-methylpyrrolidone. The aqueous solvent can also contain (i) a surfactant such as sodium dodecylbenzene sulfonate, (ii) a dispersing agent such as a polyacrylic acid or a sodium salt of carboxymethyl cellulose, and/or (iii) the like.

Note that the porous layer in accordance with an embodiment of the present invention can contain a single kind of binder resin or can contain a mixture of two or more kinds of binder resins.

Specific examples of the aramid resin such as the aromatic polyamide and the wholly aromatic polyamide encompass poly(paraphenylene terephthalamide), poly(methaphenylene isophthalamide), poly(parabenzamide), poly(metabenzamide), poly(4,4′-benzanilide terephthalamide), poly(paraphenylene-4,4′-biphenylene dicarboxylic acid amide), poly(methaphenylene-4,4′-biphenylene dicarboxylic acid amide), poly(paraphenylene-2,6-naphthalene dicarboxylic acid amide), poly(methaphenylene-2,6-naphthalene dicarboxylic acid amide), poly(2-chloroparaphenylene terephthalamide), a paraphenylene terephthalamide/2,6-dichloroparaphenylene terephthalamide copolymer, and a methaphenylene terephthalamide/2,6-dichloroparaphenylene terephthalamide copolymer. Among these aramid resins, poly(paraphenylene terephthalamide) is more preferable.

Among the above binder resins, a polyolefin, a fluorine-containing resin, an aromatic polyamide, a water-soluble polymer, or the water-insoluble polymer in the form of particles dispersed in the aqueous solvent is more preferable. Among these resins, in a case where the porous layer is arranged so as to face a positive electrode, a fluorine-containing resin is still more preferable, and a polyvinylidene fluoride-based resin is particularly preferable. This is because such a resin makes it easy to maintain various properties, such as a rate characteristic, a high-rate characteristic, and a resistance characteristic such as a solution resistance, of a nonaqueous electrolyte secondary battery even in a case where the nonaqueous electrolyte secondary battery suffers acidic deterioration during operation of the nonaqueous electrolyte secondary battery. Examples of the polyvinylidene fluoride-based resin encompass: a copolymer of vinylidene fluoride and at least one monomer selected from the group consisting of hexafluoropropylene, tetrafluoroethylene, trifluoroethylene, trichloroethylene, and vinyl fluoride; and polyvinylidene fluoride. Polyvinylidene fluoride is a homopolymer of vinylidene fluoride.

Further, the water-soluble polymer or the water-insoluble polymer which is in the form of particles dispersed in the aqueous solvent is more preferable in view of a process and an environmental impact, because water can be used as a solvent to form the porous layer. The water-soluble polymer is still more preferably cellulose ether or sodium alginate, and particularly preferably cellulose ether.

Specific examples of the cellulose ether encompass carboxymethyl cellulose (CMC), hydroxyethyl cellulose (HEC), carboxyethyl cellulose, methyl cellulose, ethyl cellulose, cyanoethyl cellulose, and oxyethyl cellulose. The cellulose ether is more preferably CMC or HEC, and particularly preferably CMC, because CMC and HEC degrade less in use over a long term and are excellent in chemical stability.

In view of adhesiveness of particles of a filler, the water-insoluble polymer in the form of particles dispersed in the aqueous solvent is preferably a homopolymer of an acrylate monomer such as methyl methacrylate, ethyl methacrylate, glycidyl methacrylate, glycidyl acrylate, methyl acrylate, ethyl acrylate, or butyl acrylate. Alternatively, the water-insoluble polymer is preferably a copolymer of two or more kinds of the monomers.

The lower limit of the content of the binder resin in the porous layer in accordance with an embodiment of the present invention is preferably more than 0.5% by weight, more preferably not less than 1% by weight, even more preferably not less than 2% by weight, with respect to the total weight of the porous layer. Meanwhile, the upper limit of the content of the binder resin in the porous layer in accordance with an embodiment of the present invention is preferably less than 40% by weight, more preferably not more than 10% by weight, with respect to the total weight of the porous layer. It is preferable that a content of the binder resin be not less than 0.5% by weight, in view of improvement of adhesion of particles of a filler, in other words, in view of preventing the filler from falling out of the porous layer. It is preferable that the content of the binder resin be less than 40% by weight, in view of a battery characteristic (in particular, resistance to ion permeation) and heat resistance.

The amount of the filler A contained in the porous layer in accordance with an embodiment of the present invention is preferably not less than 60% by weight, more preferably not less than 90% by weight, with respect to the total weight of the porous layer. The amount of the filler A contained is preferably not more than 99.5% by weight, more preferably not more than 99% by weight, even more preferably not more than 98% by weight, with respect to the total weight of the porous layer.

In a case where the amount of the filler A contained is not less than 60% by weight, the porous layer has excellent heat resistance. In a case where the amount of the filler A contained is not more than 99.5% by weight, the porous layer has excellent adhesion between particles of the filler. A nonaqueous electrolyte secondary battery laminated separator, which includes the porous layer containing the filler A, can have improved slidability and heat resistance.

According to the porous layer in accordance with an embodiment of the present invention, a value of D50 in a volume-based particle size distribution of the filler A (hereinafter also simply referred to “D50”) is preferably not more than 3 μm, and more preferably not more than 1 μm. D50 of the filler A is preferably not less than 0.01 μm, more preferably not less than 0.05 μm, and still more preferably not less than 0.1 μm.

The filler A has a D10 value in a volume particle size distribution (hereinafter also referred to simply as “D10”) within a range of preferably not less than 0.01 μm and not more than 0.7 μm, more preferably not less than 0.05 μm and not more than 0.6 μm. The filler A has a D90 value in a volume particle size distribution (hereinafter also referred to simply as “D90”) within a range of preferably not less than 0.3 μm and not more than 7 μm, more preferably not less than 0.4 μm and not more than 6 μm.

In a case where D10, D50, and D90 of the filler A included in the porous layer in accordance with an embodiment of the present invention fall within the above preferable ranges, it is possible to (i) secure good adhesiveness, good slidability, and good air permeability of the porous layer and (ii) impart excellent formability to the porous layer.

The filler A has a crushing strength within a range of preferably 100 MPa to 2000 MPa. In a case where the filler A has a crushing strength within the above range, the filler A is softer and more flexible than inorganic fillers used in conventional nonaqueous electrolyte secondary battery porous layers. A nonaqueous electrolyte secondary battery porous layer in accordance with an embodiment of the present invention, as compared to a nonaqueous electrolyte secondary battery porous layer containing a conventional inorganic filler, has high followability with respect to expansion and shrinkage of the electrodes caused by repeated charging and discharging, and can maintain the structure suitably. A nonaqueous electrolyte secondary battery porous layer in accordance with an embodiment of the present invention thus has an excellent long-term cycle characteristic as compared to a nonaqueous electrolyte secondary battery porous layer containing a conventional inorganic filler. The filler A has a crushing strength of more preferably not less than 200 MPa, even more preferably not less than 300 MPa. The filler A has a crushing strength of more preferably not more than 1800 MPa, even more preferably not more than 1500 MPa.

The filler A may have any shape. The filler A can be, for example, a particulate filler. Example of the shape of particles of the organic filler include: a spherical shape; an elliptical shape; a plate-like shape; a bar shape; an irregular shape; a fibrous shape; and shapes, such as a peanut-like shape and a tetrapod-like shape, which are formed by bonding of particles having spherical shapes or pillar shapes.

A porous layer in accordance with an embodiment of the present invention may include a filler (hereinafter referred to as “other filler”) other than a filler including a benzendiol-aldehyde resin.

The other filler may be an organic filler, which contains an organic substance, and an inorganic filler, which does not contain an organic substance.

Examples of the organic substance contained in the organic filler include a fluorine-containing resin such as polytetrafluoroethylene, a tetrafluoroethylene-hexafluoropropylene copolymer, a vinylidene fluoride-tetrafluoroethylene copolymer, polyvinylidene fluoride, and a vinylidene fluoride-hexafluoropropylene copolymer; melamine resin; and urea resin. The organic filler can be made of a single kind of organic substance or a mixture of two or more kinds of organic substances.

Examples of the inorganic filler encompass talc, clay, kaolin, silica, hydrotalcite, diatomaceous earth, magnesium carbonate, barium carbonate, magnesium sulfate, barium sulfate, aluminum hydroxide, magnesium hydroxide, magnesium oxide, titanium oxide, alumina, mica, zeolite, glass, calcium carbonate, calcium sulfate, and calcium oxide. Only one kind of inorganic filler can be contained, or a mixture of two or more kinds of inorganic fillers can be contained.

A porous layer in accordance with an embodiment of the present invention may contain a single kind of other filler or two or more kinds of other fillers.

A porous layer in accordance with an embodiment of the present invention may contain a component other than the filler A, the other filler, and the binder resin. Examples of the other component include a surfactant and wax. The content of such a component is preferably 0% by weight to 10% by weight with respect to the total weight of the porous layer.

The porous layer in accordance with an embodiment of the present invention has a thickness of preferably 0.5 μm to 10 pm (per layer), and more preferably 1 μm to 7 μm (per layer), in order to secure (i) adhesiveness of the porous layer to an electrode and (ii) a high energy density.

In view of ion permeability, the porous layer in accordance with an embodiment of the present invention preferably has a sufficiently porous structure. Specifically, the porous layer preferably has a porosity of 30% to 70%.

The porosity can be calculated by, for example, the following formula (1), where (i) W is a weight (g) of a porous layer having a certain volume (8 cm×8 cm×d (cm) (d: thickness)), (ii) the thickness d (μm) of the porous layer, and (iii) ρ (g/cm³) is an absolute specific gravity of the porous layer:

Porosity (%)=(1−{(W/τ)/(8×8×d)})×100 (1)

Furthermore, the porous layer in accordance with an embodiment of the present invention has an average pore diameter within a range of preferably 20 nm to 100 nm.

The average pore diameter can be calculated by, for example, (i) observing the porous layer in accordance with an embodiment of the present invention from a top surface with use of a scanning electron microscope (SEM), (ii) measuring respective pore diameters of a plurality of voids randomly selected, and (iii) obtaining an average value of the pore diameters thus measured.

Method for Preparing a Filler Including a Benzendiol-Aldehyde Resin>

A filler including a benzendiol-aldehyde resin for an embodiment of the present invention may be prepared by, for example, a method including the following steps (i) and (ii):

(i) Mixing the benzendiol-based monomer, the aldehyde-based monomer, a catalyst, and a solvent with one another, stirring the mixture at a constant temperature, and keeping the resulting mixture at a constant temperature for polymerization reaction to obtain a suspension of a filler including a benzendiol-aldehyde resin

(ii) Separating the filler including the benzendiol-aldehyde resin from the suspension of the filler including the benzendiol-aldehyde resin which suspension has been obtained in the step (i)

The solvent in the step (i) is, for example, water. The catalyst in the step (i) is, for example, sodium carbonate. The catalyst in the step (i) is preferably a basic catalyst for formation of the three-dimensional crosslinked structure described above.

For the step (i) above, the molar ratio of the benzendiol-based monomer to the aldehyde-based monomer is preferably within a range of 1:0.5 to 1:3.

The aldehyde-based monomer may be replaced with a compound that serves as a supply source of the aldehyde-based monomer. Examples of such a compound include paraformaldehyde and glyoxal.

How a filler including a benzendiol-aldehyde resin is separated from the suspension in the step (ii) is not limited to any particular method. The method may be a publicly known method such as centrifugation.

Method for Producing Nonaqueous Electrolyte Secondary Battery Porous Layer>

A method for producing the porous layer in accordance with an embodiment of the present invention is not limited to any particular one. For example, it is possible to use a method in which a porous layer containing the filler A and the binder resin is formed on a base material by carrying out any one of the following processes (1) to (3). In a case where the following process (2) or (3) is carried out, a porous layer can be produced by further drying a deposited binder resin so as to remove a solvent. In a coating solution used in each of the processes (1) to (3), the filler A may be dispersed and the binder resin may be dissolved. Examples of the base material encompass, but are not particularly limited to, a positive electrode, a negative electrode, and a polyolefin porous film which serves as a base material of a nonaqueous electrolyte secondary battery laminated separator (described later) in accordance with an embodiment of the present invention. The solvent may be regarded as doubling as a solvent in which the binder resin is dissolved and as a dispersion medium in which the binder resin or the filler A is dispersed.

(1) A process in which (i) a base material is coated with a coating solution, which is to form the porous layer and contains the filler A and the binder resin, and then (ii) the base material is dried for removal of a solvent from the coating solution, so that the porous layer is formed.

(2) A process in which (i) a surface of the base material is coated with a coating solution, which is to form the porous layer and contains the filler A and the binder resin, and then (ii) the base material is immersed into a deposition solvent (which is a poor solvent for the binder resin) so that the porous layer is formed by deposition of the binder resin.

(3) A process in which (i) a surface of the base material is coated with a coating solution, which is to form the porous layer and contains the filler A and the binder resin, and then (ii) the coating solution is made acidic with use of a low-boiling-point organic acid so that the porous layer is formed by deposition of the binder resin.

The solvent for the coating solution is preferably a solvent that does not adversely affect the base material, that allows the binder resin to be dissolved or dispersed therein uniformly and stably, and that allows the filler A to be dispersed therein uniformly and stably. Examples of the solvent include N-methylpyrrolidone, N,N-dimethylacetamide, N,N-dimethylformamide, acetone, and water.

The deposition solvent is preferably isopropyl alcohol or t-butyl alcohol, for example.

For the process (3), the low-boiling-point organic acid can be, for example, paratoluene sulfonic acid or acetic acid.

The porous layer normally has, on one surface of the base material, a coating amount (weight per unit area) within a range of preferably 0.5 g/m² to 20 g/m², more preferably 0.5 g/m² to 10 g/m², even more preferably 0.5 g/m² to 7 g/m², in terms of the solid content in view of adhesiveness to an electrode (electrode sheet) and ion permeability. That is, an amount of the coating solution with which the base material is coated is preferably adjusted so that the porous layer to be obtained will have a coating amount (weight per unit area) within the above ranges.

In any of the processes (1) to (3), in a case where a change is made to the amount of binder resin which is to form a porous layer and which is dissolved or dispersed in a solution, it is possible to adjust the volume of binder resin which is contained per square meter of a porous layer having undergone immersion in an electrolyte and which has absorbed the electrolyte.

Further, changing the amount of solvent in which the binder resin for the porous layer is to be dissolved or dispersed can adjust the porosity and average pore diameter of a porous layer having undergone immersion in an electrolyte.

A suitable solid content concentration of the coating solution may vary depending on, for example, the kind of the filler. In general, the solid content concentration is preferably more than 10% by weight and not more than 40% by weight.

When the base material is coated with the coating solution, a coating shear rate may vary depending on, for example, the kind of the filler. In general, the coating shear rate is preferably not less than 2 (1/s) and more preferably 4 (1/s) to 50 (1/s).

[Nonaqueous Electrolyte Secondary Battery Laminated Separator]

A nonaqueous electrolyte secondary battery laminated separator in accordance with an embodiment of the present invention includes (i) a polyolefin porous film and (ii) a nonaqueous electrolyte secondary battery porous layer in accordance with an embodiment of the present invention which is disposed on at least one surface of the polyolefin porous film.

<Polyolefin Porous Film>

A polyolefin porous film in accordance with an embodiment of the present invention (hereinafter also referred to simply as “porous film”) includes a polyolefin-based resin as a main component. The polyolefin porous film has therein many pores, connected to one another, so that a gas and a liquid can pass through the polyolefin porous film from one side to the other side. The porous film may by itself serve as a nonaqueous electrolyte secondary battery separator. The porous film may also serve as a base material of a nonaqueous electrolyte secondary battery laminated separator including the porous layer described above.

The present specification uses the term “nonaqueous electrolyte secondary battery laminated separator” as well to refer to a laminated body in which the porous layer is disposed on at least one surface of the polyolefin porous film. Further, the nonaqueous electrolyte secondary battery separator in accordance with an embodiment of the present invention may include, in addition to a polyolefin porous film, another layer(s) such as an adhesive layer, a heat-resistant layer, and/or a protective layer.

The porous film contains a polyolefin at a proportion of not less than 50% by volume, preferably not less than 90% by volume, more preferably not less than 95% by volume, with respect to the entire porous film. The polyolefin preferably contains a high molecular weight component having a weight-average molecular weight within a range of 5×10⁵ to 15×10⁶. In particular, the polyolefin more preferably contains a high molecular weight component having a weight-average molecular weight of not less than 1,000,000 because such a polyolefin allows the nonaqueous electrolyte secondary battery separator or nonaqueous electrolyte secondary battery laminated separator to have a higher strength.

Specific examples of the polyolefin (thermoplastic resin) include a homopolymer or a copolymer each produced by polymerizing a monomer such as ethylene, propylene, 1-butene, 4-methyl-1-pentene, and 1-hexene. Examples of the homopolymer include polyethylene, polypropylene, and polybutene. Examples of the copolymer include an ethylene-propylene copolymer.

Among the above examples, polyethylene is preferable as it is capable of preventing a flow of an excessively large electric current at a lower temperature. This preventing of an excessively large electric current is also referred to as shutdown. Examples of the polyethylene include low-density polyethylene, high-density polyethylene, linear polyethylene (ethylene-a-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is further preferable.

The porous film has a film thickness of preferably 4 μm to 40 μm, more preferably 5 μm to 30 μm, still more preferably 6 μm to 15 μm.

The porous film can have a weight per unit area which weight is appropriately determined in view of the strength, film thickness, weight, and handleability. The weight per unit area is, however, within a range of preferably 4 g/m² to 20 g/m², more preferably 4 g/m² to 12 g/m², even more preferably 5 g/m² to 10 g/m², so as to allow a nonaqueous electrolyte secondary battery to have a higher weight energy density and a higher volume energy density.

The porous film has an air permeability of preferably 30 sec/100 mL to 500 sec/100 mL, more preferably 50 sec/100 mL to 300 sec/100 mL, in terms of Gurley values. A porous film having an air permeability within the above range can have sufficient ion permeability. A nonaqueous electrolyte secondary battery laminated separator in which the porous layer described above is disposed on a porous film has an air permeability of preferably 30 sec /100 mL to 1000 sec/100 mL, more preferably 50 sec/100 mL to 800 sec/100 mL in terms of Gurley values. The nonaqueous electrolyte secondary battery laminated separator, which has the above air permeability, allows the nonaqueous electrolyte secondary battery to have sufficient ion permeability.

The porous film has a porosity of preferably 20% by volume to 80% by volume, more preferably 30% by volume to 75% by volume, so as to (i) retain a larger amount of electrolyte and (ii) obtain the function of reliably preventing a flow of an excessively large electric current at a lower temperature. Further, in order to obtain sufficient ion permeability and prevent particles from entering the positive electrode and/or the negative electrode, the porous film has pores each having a pore size of preferably not larger than 0.30 μm, more preferably not larger than 0.14 μm, even more preferably not larger than 0.10 μm.

[Method for Producing Polyolefin Porous Film]

The method for producing the polyolefin porous film is not limited to any particular one. An example method includes (i) kneading, for example, a polyolefin-based resin, a pore forming agent such as an inorganic bulking agent and a plasticizing agent, and optionally an antioxidant, (ii) extruding the kneaded product into a sheet-shaped polyolefin resin composition, (iii) removing the pore forming agent from the sheet-shaped polyolefin resin composition with use of a suitable solvent, and then (iv) stretching the polyolefin resin composition, from which the pore forming agent has been removed, to produce a polyolefin porous film.

The inorganic bulking agent is not limited to any particular one, and may be an inorganic filler, specifically calcium carbonate, for example. The plasticizing agent is not limited to any particular one, and may be a low molecular weight hydrocarbon such as liquid paraffin.

Specifically, the method can include the following steps:
(A) kneading an ultra-high molecular weight polyethylene, a low molecular weight polyethylene having a weight-average molecular weight of not more than 10,000, a pore forming agent such as calcium carbonate or a plasticizing agent, and an antioxidant with one another to produce a polyolefin resin composition,
(B) rolling the above-produced polyolefin resin composition with use of a pair of reduction rollers and gradually cooling the polyolefin resin composition while pulling the polyolefin resin composition with use of a wind-up roller rotating at a rate different from that of the pair of rollers to form a sheet,
(C) removing the pore forming agent from the above-formed sheet with use of a suitable solvent, and
(D) stretching the sheet, from which the pore forming agent has been removed, at a suitable stretch ratio.

<Method for Producing Nonaqueous Electrolyte Secondary Battery Laminated Separator>

A method for producing the nonaqueous electrolyte secondary battery laminated separator in accordance with an embodiment of the present invention can be, for example, the above-described method for producing the porous layer in which the above-described polyolefin porous film is used as a base material which is coated with the coating solution.

[Nonaqueous Electrolyte Secondary Battery Member and Nonaqueous Electrolyte Secondary Battery]

A member for a nonaqueous electrolyte secondary battery (hereinafter referred to as “nonaqueous electrolyte secondary battery member”) in accordance with an embodiment of the present invention is obtained by arranging a positive electrode, a porous layer in accordance with an embodiment of the present invention or a nonaqueous electrolyte secondary battery laminated separator in accordance with an embodiment of the present invention, and a negative electrode, the positive electrode, the porous layer or the nonaqueous electrolyte secondary battery laminated separator, and the negative electrode being arranged in this order.

A nonaqueous electrolyte secondary battery in accordance with an embodiment of the present invention includes (i) a porous layer in accordance with an embodiment of the present invention or (ii) a nonaqueous electrolyte secondary battery laminated separator in accordance with an embodiment of the present invention.

The nonaqueous electrolyte secondary battery in accordance with an embodiment of the present invention is, for example, a nonaqueous secondary battery that achieves an electromotive force through doping with and dedoping of lithium, and is a lithium-ion secondary battery that includes a nonaqueous electrolyte secondary battery member including a positive electrode, a porous layer in accordance with an embodiment of the present invention, a polyolefin porous film, and a negative electrode, which are disposed in this order, that is, a lithium-ion secondary battery member that includes a positive electrode, a nonaqueous electrolyte secondary battery laminated separator in accordance with an embodiment of the present invention, and a negative electrode, which are disposed in this order. Note that constituent elements of the nonaqueous electrolyte secondary battery other than the porous layer are not limited to those described below.

The nonaqueous electrolyte secondary battery in accordance with an embodiment of the present invention is typically configured so that a battery element is enclosed in an exterior member, the battery element including (i) a structure in which the negative electrode and the positive electrode face each other through the porous layer in accordance with an embodiment of the present invention or the nonaqueous electrolyte secondary battery laminated separator in accordance with an embodiment of the present invention and (ii) an electrolyte with which the structure is impregnated. The nonaqueous electrolyte secondary battery in accordance with an embodiment of the present invention is preferably a secondary battery including a nonaqueous electrolyte, and is particularly preferably a lithium-ion secondary battery. Note that the doping means occlusion, support, adsorption, or insertion, and means a phenomenon in which lithium ions enter an active material of an electrode (such as a positive electrode).

A nonaqueous electrolyte secondary battery member in accordance with an embodiment of the present invention includes a porous layer in accordance with an embodiment of the present invention which porous layer contains a filler including a benzendiol-aldehyde resin. This advantageously allows a nonaqueous electrolyte secondary battery including the nonaqueous electrolyte secondary battery member to have an improved long-term cycle characteristic. A nonaqueous electrolyte secondary battery in accordance with an embodiment of the present invention includes a porous layer in accordance with an embodiment of the present invention which porous layer contains a filler including a benzendiol-aldehyde resin. This advantageously allows the long-term cycle characteristic to be excellent.

<Positive Electrode>

A positive electrode included in the nonaqueous electrolyte secondary battery member in accordance with an embodiment of the present invention or in the nonaqueous electrolyte secondary battery in accordance with an embodiment of the present invention is not limited to any particular one, provided that the positive electrode is one that is generally used as a positive electrode of a nonaqueous electrolyte secondary battery. Examples of the positive electrode encompass a positive electrode sheet having a structure in which an active material layer including a positive electrode active material and a binder agent is formed on a current collector. The active material layer can further include an electrically conductive agent.

The positive electrode active material is, for example, a material capable of being doped with and dedoped of lithium ions. Specific examples of such a material encompass a lithium complex oxide containing at least one transition metal such as V, Mn, Fe, Co, or Ni. Among such lithium complex oxides, the following lithium complex oxides have a high average discharge potential and are therefore preferable: (i) a lithium complex oxide having an α-NaFeO₂ structure, such as lithium nickelate or lithium cobaltate and (ii) a lithium complex oxide having a spinel structure, such as lithium manganese spinel. The lithium complex oxide can further contain any of various metal elements, and is more preferably a complex lithium nickelate.

Furthermore, the lithium nickel complex oxide still more preferably contains at least one metallic element selected from the group consisting of Ti, Zr, Ce, Y, V, Cr, Mn, Fe, Co, Cu, Ag, Mg, Al, Ga, In, and Sn at a proportion of 0.1 mol % to 20 mol % with respect to the sum of the number of moles of the at least one metal element and the number of moles of Ni in the lithium nickelate. This is because such a complex lithium nickelate leads to an excellent cycle characteristic when used in a high-capacity battery. Among others, an active material that contains Al or Mn and that further contains Ni at a proportion of not less than 85%, more preferably not less than 90%, is particularly preferable. This is because a nonaqueous electrolyte secondary battery including a positive electrode containing such an active material has an excellent cycle characteristic in high-capacity use.

Examples of the electrically conductive agent encompass carbonaceous materials such as natural graphite, artificial graphite, cokes, carbon black, pyrolytic carbons, carbon fiber, and a fired product of an organic polymer compound. It is possible to use (i) only one kind of the above electrically conductive agents or (ii) two or more kinds of the above electrically conductive agents in combination, for example, a mixture of artificial graphite and carbon black.

Examples of the binding agent encompass: thermoplastic resins such as polyvinylidene fluoride, a copolymer of vinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, a thermoplastic polyimide, polyethylene, and polypropylene; acrylic resin; and styrene butadiene rubber. Note that the binding agent also serves as a thickener.

The positive electrode mix may be prepared by, for example, a method of applying pressure to the positive electrode active material, the electrically conductive agent, and the binding agent on the positive electrode current collector or a method of using an appropriate organic solvent so that the positive electrode active material, the electrically conductive agent, and the binding agent are in a paste form.

Examples of the positive electrode current collector encompass electric conductors such as Al, Ni, and stainless steel. Among these, Al is preferable because Al is easily processed into a thin film and is inexpensive.

The positive electrode sheet may be produced, that is, the positive electrode mix may be supported by the positive electrode current collector, by for example a method in which pressure is applied to the positive electrode active material, the electrically conductive agent, and the binding agent on the positive electrode current collector to form a positive electrode mix thereon or a method in which (i) an appropriate organic solvent is used so that the positive electrode active material, the electrically conductive agent, and the binding agent are in a paste form to provide a positive electrode mix, (ii) the positive electrode mix is applied to the positive electrode current collector, (iii) the applied positive electrode mix is dried so that a sheet-shaped positive electrode mix is prepared, and (iv) then pressure is applied to the sheet-shaped positive electrode mix so that the sheet-shaped positive electrode mix is firmly fixed to the positive electrode current collector.

<Negative Electrode>

A negative electrode included in the nonaqueous electrolyte secondary battery member in accordance with an embodiment of the present invention or in the nonaqueous electrolyte secondary battery in accordance with an embodiment of the present invention is not limited to any particular one, provided that the negative electrode is one that is generally used as a negative electrode of a nonaqueous electrolyte secondary battery. Examples of the negative electrode encompass a negative electrode sheet having a structure in which an active material layer including a negative electrode active material and a binding agent is formed on a current collector. The active material layer can further include an electrically conductive agent.

Examples of the negative electrode active material encompass (i) a material capable of being doped with and dedoped of lithium ions, (ii) a lithium metal, and (iii) a lithium alloy. Specific examples of the material encompass: carbonaceous materials such as natural graphite, artificial graphite, cokes, carbon black, pyrolytic carbons, carbon fiber, and a fired product of an organic polymer compound; chalcogen compounds such as an oxide and a sulfide that are doped with and dedoped of lithium ions at an electric potential lower than that for the positive electrode; metals such as aluminum (Al), lead (Pb), tin (Sn), bismuth (Bi), or silicon (Si), each of which is alloyed with alkali metal; cubic intermetallic compounds (AlSb, Mg₂Si, and NiSi₂) having lattice spaces in which alkali metals can be provided; and lithium nitrogen compounds (Li₃,MₓN (where M represents a transition metal)). Among the above negative electrode active materials, a carbonaceous material that contains, as a main component, a graphite material such as natural graphite or artificial graphite is preferable. This is because such a carbonaceous material is high in potential evenness, and a great energy density can be obtained in a case where the carbonaceous material, which is low in average discharge potential, is combined with the positive electrode. The negative electrode active material can alternatively be a mixture of graphite and silicon, preferably containing Si at a proportion of not less than 5%, and more preferably not less than 10%, with respect to carbon (C) constituting the graphite.

The negative electrode mix can be prepared by, for example, a method in which pressure is applied to the negative electrode active material on a negative electrode current collector or a method in which an appropriate organic solvent is used so that the negative electrode active material is in a paste form.

Examples of the negative electrode current collector encompass electric conductors such as Cu, Ni, and stainless steel. Among these, Cu is preferable because it is not easily alloyed with lithium in the case of a lithium-ion secondary battery in particular and is easily processed into a thin film.

The negative electrode sheet may be produced, that is, the negative electrode mix may be supported by the negative electrode current collector, by for example a method in which pressure is applied to the negative electrode active material on the negative electrode current collector to form a negative electrode mix thereon or a method in which (i) an appropriate organic solvent is used so that the negative electrode active material is in a paste form to provide a negative electrode mix, (ii) the negative electrode mix is applied to the negative electrode current collector, (iii) the applied negative electrode mix is dried so that a sheet-shaped negative electrode mix is prepared, and (iv) then pressure is applied to the sheet-shaped negative electrode mix so that the sheet-shaped negative electrode mix is firmly fixed to the negative electrode current collector. The above paste preferably includes the above electrically conductive agent and the binding agent.

<Nonaqueous Electrolyte>

A nonaqueous electrolyte for use in the nonaqueous electrolyte secondary battery in accordance with an embodiment of the present invention is a nonaqueous electrolyte generally used in a nonaqueous electrolyte secondary battery, and is not limited to any particular one. Examples of the nonaqueous electrolyte encompass a nonaqueous electrolyte prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is possible to use only one kind of the above lithium salts or two or more kinds of the above lithium salts in combination. It is preferable to use, among the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃.

Specific examples of the organic solvent in the nonaqueous electrolyte in an embodiment of the present invention encompass: carbonates such as ethylene carbonate, propylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into any of the organic solvents described above. It is possible to use only one kind of the above organic solvents or two or more kinds of the above organic solvents in combination. Among the above organic solvents, carbonates are preferable. A mixed solvent of a cyclic carbonate and an acyclic carbonate or a mixed solvent of a cyclic carbonate and an ether is more preferable. The mixed solvent of a cyclic carbonate and an acyclic carbonate is still more preferably a mixed solvent of ethylene carbonate, dimethyl carbonate, and ethyl methyl carbonate. This is because such a mixed solvent leads to a wider operating temperature range, and is not easily decomposed even in a case where a negative electrode active material is a graphite material such as natural graphite or artificial graphite.

<Nonaqueous Electrolyte Secondary Battery Member Production Method and Nonaqueous Electrolyte Secondary Battery Production Method>

A nonaqueous electrolyte secondary battery member in accordance with an embodiment of the present invention can be produced by, for example, arranging a positive electrode, a porous layer in accordance with an embodiment of the present invention or a nonaqueous electrolyte secondary battery laminated separator in accordance with an embodiment of the present invention, and a negative electrode in this order.

A nonaqueous electrolyte secondary battery in accordance with an embodiment of the present invention can be produced by, for example, (i) producing a nonaqueous electrolyte secondary battery member as described above, (ii) inserting the nonaqueous electrolyte secondary battery member into a container that will serve as a housing of a nonaqueous electrolyte secondary battery, (iii) filling the container with a nonaqueous electrolyte, and (iv) hermetically sealing the container while reducing pressure inside the container.

The nonaqueous electrolyte secondary battery is not particularly limited in shape and can have any shape such as the shape of a thin plate (sheet), a disk, a cylinder, or a prism such as a cuboid. The nonaqueous electrolyte secondary battery member and the nonaqueous electrolyte secondary battery can each be produced by any method, and can each be produced by a conventionally publicly known method.

The present invention is not limited to the embodiments, but can be altered variously by a skilled person in the art within the scope of the claims. The present invention also encompasses, in its technical scope, any embodiment derived by appropriately combining technical means disclosed in differing embodiments. Further, it is possible to form a new technical feature by combining the technical means disclosed in the respective embodiments.

### EXAMPLES

The following description will discuss embodiments of the present invention in more detail by Examples and Comparative Examples. Note, however, that the present invention is not limited to these Examples and Comparative Examples.

In each of Examples and Comparative Examples, physical properties and the like of a nonaqueous electrolyte secondary battery laminated separator, an A layer (polyolefin porous film), a B layer (porous layer), and a nonaqueous electrolyte secondary battery were measured by the following methods.

(1) Thickness (Unit: μm)

A total thickness of the nonaqueous electrolyte secondary battery laminated separator, a thickness of the A layer, and a thickness of the B layer were each measured with use of a high-resolution digital measuring device available from Mitutoyo Corporation.

(2) Weight Per Unit Area (Unit: g/m²):

A sample in the form of a 6.4 cm×4 cm rectangle was cut out from the nonaqueous electrolyte secondary battery laminated separator, and the weight W (g) of the sample was measured. Then, the weight per unit area of the nonaqueous electrolyte secondary battery laminated separator was calculated in accordance with the following Formula:

Weight per unit area (g/m²)=W/(0.064×0.04)

The weight per unit area of the A layer was likewise calculated. The weight per unit area of the B layer was calculated by subtracting the weight per unit area of the A layer from the weight per unit area of the nonaqueous electrolyte secondary battery laminated separator.

(3) Average Particle Diameter, Volume-Based Particle Size Distribution (D10, D50, D90) (Unit: μm):

D10, D50, and D90 each as a particle diameter of filler were measured with use of MICROTRAC (MODEL: MT-3300EXII) available from Nikkiso Co., Ltd.

(4) Crushing Strength of Particles (Unit: MPa)

The crushing force of minutely small particles was measured with use of model No. NS-A100 available from Nano Seeds Corporation. A sample was dispersed on a stage by free fall, and the crushing force was then measured with use of a dedicated needle. A waveform chart was recorded of the pressing force of the needle. The crushing force F(N) was the difference between the peak value and baseline during the crushing operation. The crushing strength (Pa) was calculated on the basis of the equation below.

Crushing strength=2.8×F/(n×D²)

where F represents the crushing force (N), and D(m) represents the particle diameter.

The particle diameter D was determined with use of image analysis software (LeiCa EZ) from an image captured during the measurement.

(5) Long-Term Cycle Characteristic (Unit: %)

Nonaqueous electrolyte secondary batteries each of which was produced in one of the Examples and Comparative Examples and each of which had not been subjected to any charge-discharge cycle were each subjected to four cycles of initial charge and discharge at 25° C. Each of the four cycles of initial charge and discharge was carried out (i) at a voltage ranging from 2.7 V to 4.1 V, (ii) with CC-CV charge at a charge current value of 0.2 C and a terminal current condition of 0.02 C, and (iii) with CC discharge at a discharge current value of 0.2 C. The term “1 C” refers to the value of an electric current at which a battery rated capacity defined as a one-hour rate discharge capacity is discharged in one hour. The term “CC-CV charge” is a charging method in which (i) a battery is charged at a constant electric current that has been set and (ii) after a certain voltage is reached, the certain voltage is maintained while the electric current is being reduced to a terminal current condition. The term “CC discharge” is a discharging method in which a battery is discharged at a constant electric current until a certain voltage is reached. The terms “1 C”, “CC-CV charge” and “CC discharge” mean the same in the description below.

The nonaqueous electrolyte secondary batteries, which had been subjected to initial charge and discharge, were each subjected to 100 charge-discharge cycles at 55° C. Each of the 100 charge-discharge cycles was carried out (i) at a voltage ranging from 2.7 V to 4.2 V, (ii) with CC-CV charge at a charge current value of 1 C and a terminal current condition of 0.02 C, and (iii) with CC discharge at a discharge current value of 10 C. The discharge capacity (unit: mAh) in the first cycle and the discharge capacity in the hundredth cycle were measured. The capacity maintaining ratio (unit: %) after 100 cycles was calculated from the measurement results on the basis of Formula (3) below.

Capacity maintaining ratio (%) after 100 cycles =discharge capacity (mAh) in the hundredth cycle/discharge capacity (mAh) in the first cycle×100 . . . (3)

### Example 1

The A layer (porous film) below and the B layer (porous layer) below were used to form a nonaqueous electrolyte secondary battery laminated separator.

<A Layer>

A polyolefin porous film was prepared with use of polyethylene. Specifically, 70 parts by weight of an ultra-high molecular weight polyethylene powder (340M, available from Mitsui Chemicals, Inc.) and 30 parts by weight of a polyethylene wax (FNP-0115, available from Nippon Seiro Co., Ltd.) having a weight-average molecular weight of 1,000 were mixed with each other so that a mixed polyethylene was prepared. Then, with respect to 100 parts by weight of the mixed polyethylene thus obtained, 0.4 parts by weight of an antioxidant (Irg1010, available from Ciba Specialty Chemicals Inc.), 0.1 parts by weight of an antioxidant (P168, available from Ciba Specialty Chemicals Inc.), and 1.3 parts by weight of sodium stearate were added. Then, calcium carbonate (available from Maruo Calcium Co., Ltd.) having an average particle diameter of 0.1 μm was further added so that the calcium carbonate accounted for 38% by volume of the total volume. Then, the above composition in powder form was mixed with use of a Henschel mixer, and was then melt-kneaded by a twin screw kneading extruder. This produced a polyethylene resin composition. Next, the polyethylene resin composition was rolled with use of a pair of rollers each having a surface temperature of 150′C., so that a sheet was prepared. This sheet was immersed in an aqueous hydrochloric acid solution, prepared by mixing 4 mol/L of hydrochloric acid and 0.5% by weight of nonionic surfactant with each other, to dissolve the calcium carbonate into the aqueous solution and remove the calcium carbonate from the sheet. Then, the sheet, from which the calcium carbonate had been removed, was stretched at 105° C. at a stretch ratio of 6 times, so that a polyolefin porous film (A layer) was prepared.

<B Layer>

Water, resorcin, 37% formalin, and sodium carbonate as a catalyst were mixed with one another so that the molar ratio of the resorcin to formaldehyde in the formalin was 2:1. The resulting mixture was stirred at 80° C. and was then kept at 80° C. for polymerization reaction. This produced a suspension containing fine particles of a resorcin-formaldehyde resin (RF resin). The suspension thus obtained was centrifuged, so that the fine particles of the RF resin precipitated. Then, a supernatant dispersion medium was removed while the precipitated fine particles of the RF resin were left. Then, the fine particles of the RF resin were cleaned by carrying out twice a cleaning operation including (i) adding, to the fine particles of the RF resin, water which served as a cleaning liquid, (ii) stirring the resulting mixture, and (iii) centrifuging the mixture so as to remove the cleaning liquid. In other words, a cleaning operation was carried out two times in total. The cleaned fine particles of the RF resin were immersed in t-butyl alcohol, and were then freeze-dried for removal of the t-butyl alcohol. This produced a filler 1. The filler 1 was made substantially only of a benzendiol-aldehyde resin. In other words, the filler 1 contained a benzendiol-aldehyde resin in an amount of not less than 98%. The filler 1 had a particle size distribution in which D10 was 0.69 μm, D50 was 1.47 μm, and D90 was 6.1 μm. The filler 1 had a crushing strength of 700 MPa.

The filler 1, CMC, and a mixed solvent of water and isopropyl alcohol were mixed with one another to prepare a mixed liquid in such a manner that (i) 8 parts by weight of CMC were mixed with 100 parts by weight of the filler 1, that (ii) the solid-content concentration (that is, the total concentration of the filler 1 and the CMC) was 20.0% by weight, and that (iii) the solvent composition of the above mixed solvent was 95% by weight of water and 5% by weight of isopropyl alcohol. The mixed liquid thus produced was a dispersion liquid of the filler 1. Then, the dispersion liquid thus obtained was dispersed by high pressure (high-pressure dispersion conditions: 100 MPa×3 passes) with use of a high-pressure dispersing device (available from Sugino Machine Limited; Star Burst), so that a coating solution 1 was prepared.

<Nonaqueous Electrolyte Secondary Battery Laminated Separator>

One surface of the A layer was subjected to a corona treatment at 20 W/(m²/min). Then, the surface of the A layer, which surface had been subjected to the corona treatment, was coated with the coating solution 1 with use of a gravure coater, so that a coating film was formed. In so doing, for the purpose of uniformly coating the A layer with the coating solution 1, tension was applied to the A layer while a coated part of the A layer was sandwiched between pinch rolls on parts in front of and behind the coated part. Then, the coating film was dried, so that a B layer was formed. This produced a nonaqueous electrolyte secondary battery laminated separator 1 in which the B layer was disposed on the one surface of the A layer.

The nonaqueous electrolyte secondary battery laminated separator 1 had an overall film thickness of 18.3 μm. The A layer had a film thickness of 12.0 μm. The B layer had a film thickness of 6.3 μm. The nonaqueous electrolyte secondary battery laminated separator 1 had an overall weight per unit area of 12.3 g/m². The A layer had a weight per unit area of 6.8 g/m². The B layer had a weight per unit area of 5.5 g/m².

<Preparation of Nonaqueous Electrolyte Secondary Battery>

(Preparation of Positive Electrode)

A commercially available positive electrode was used. The positive electrode was produced by coating an aluminum foil with LiNi_{0.5}Mn_{0.3}Co_{0.2}O₂/electrically conductive agent/PVDF (weight ratio 92:5:3). The aluminum foil was partially cut off so that a positive electrode active material layer was present in an area of 45 mm×30 mm and that that area was surrounded by an area with a width of 13 mm in which area no positive electrode active material layer was present. The cutoff was used as a positive electrode. The positive electrode active material layer had a thickness of 58 μm and a density of 2.50 g/cm³. The positive electrode had a capacity of 174 mAh/g.

(Preparation of Negative Electrode)

A commercially available negative electrode was used. The negative electrode was produced by coating a copper foil with graphite/styrene-1,3-butadiene copolymer/sodium carboxymethyl cellulose (weight ratio 98:1:1). The copper foil was partially cut off so that a negative electrode active material layer was present in an area of 50 mm×35 mm and that that area was surrounded by an area with a width of 13 mm in which area no negative electrode active material layer was present. The cutoff was used as a negative electrode. The negative electrode active material layer had a thickness of 49 μm and a density of 1.40 g/cm³. The negative electrode had a capacity of 372 mAh/g.

<Assembly of Nonaqueous Electrolyte Secondary Battery>

In a laminate pouch, the positive electrode, the nonaqueous electrolyte secondary battery laminated separator 1, and the negative electrode were disposed (arranged) in this order so that (i) the B layer of the nonaqueous electrolyte secondary battery laminated separator 1 and the positive electrode active material layer of the positive electrode were in contact with each other and (ii) the A layer of the nonaqueous electrolyte secondary battery laminated separator 1 and the negative electrode active material layer of the negative electrode were in contact with each other. This produced a nonaqueous electrolyte secondary battery member 1. In so doing, the positive electrode and the negative electrode were arranged so that the positive electrode active material layer of the positive electrode had a main surface that was entirely covered by the main surface of the negative electrode active material layer of the negative electrode. In other words, in the nonaqueous electrolyte secondary battery member 1 produced, the positive electrode and the negative electrode were arranged so that the positive electrode active material layer of the positive electrode had a main surface that entirely overlapped with the main surface of the negative electrode active material layer of the negative electrode.

Subsequently, the nonaqueous electrolyte secondary battery member 1 was put into a bag made of an aluminum layer and a heat seal layer which were disposed on each other. Then, 0.23 mL of nonaqueous electrolyte was put into the bag. The nonaqueous electrolyte had been prepared by dissolving LiPF₆ in a mixed solvent in which ethylene carbonate, ethyl methyl carbonate, and diethyl carbonate were mixed at a ratio of 3:5:2 (volume ratio), so that a concentration of the LiPF₆ would become 1 mol/L. The bag was then heat-sealed while the pressure inside the bag was reduced. This produced a nonaqueous electrolyte secondary battery 1.

### Example 2

Operations similar to those of Example 1 were carried out except that water, resorcin, 37% formalin, and sodium carbonate as a catalyst were mixed with one another so that the molar ratio of the resorcin to formaldehyde in the formalin was 1:2. This produced a filler. The filler produced was a filler 2. The filler 2 was made substantially only of a benzendiol-aldehyde resin. In other words, the filler 2 contained a benzendiol-aldehyde resin in an amount of not less than 98%. The filler 2 produced had a particle size distribution in which D10 was 0.27 μm, D50 was 0.43 μm, and D90 was 0.66 μm. The filler 2 had a crushing strength of 1200 MPa.

A nonaqueous electrolyte secondary battery laminated separator 2 was prepared by a method similar to the method for Example 1 except that the filler 1 was replaced with the filler 2. Then, a nonaqueous electrolyte secondary battery 2 was prepared by a method similar to the method for Example 1 except that the nonaqueous electrolyte secondary battery laminated separator 1 was replaced with the nonaqueous electrolyte secondary battery laminated separator 2.

The nonaqueous electrolyte secondary battery laminated separator 2 had an overall film thickness of 17.6 μm. The A layer had a film thickness of 12.0 μm. The B layer had a film thickness of 5.6 μm. The nonaqueous electrolyte secondary battery laminated separator 2 had an overall weight per unit area of 13.3 g/m². The A layer had a weight per unit area of 6.8 g/m². The B layer had a weight per unit area of 6.5 g/m².

### Example 3

Operations similar to those of Example 1 were carried out except that water, resorcin, 37% formalin, and sodium carbonate as a catalyst were mixed with one another so that the molar ratio of the resorcin to formaldehyde in the formalin was 1:3. This produced a filler. The filler produced was a filler 3. The filler 3 was made substantially only of a benzendiol-aldehyde resin. In other words, the filler 3 contained a benzendiol-aldehyde resin in an amount of not less than 98%. The filler 3 had a particle size distribution in which D10 was 0.33 μm, D50 was 0.89 μm, and D90 was 1.70 μm.

A nonaqueous electrolyte secondary battery laminated separator 3 was prepared by a method similar to the method for Example 1 except that the filler 1 was replaced with the filler 3. Then, a nonaqueous electrolyte secondary battery 3 was prepared by a method similar to the method for Example 1 except that the nonaqueous electrolyte secondary battery laminated separator 1 was replaced with the nonaqueous electrolyte secondary battery laminated separator 3.

The nonaqueous electrolyte secondary battery laminated separator 3 had an overall film thickness of 17.8 μm. The A layer had a film thickness of 12.0 μm. The B layer had a film thickness of 5.8 μm. The nonaqueous electrolyte secondary battery laminated separator 3 had an overall weight per unit area of 13.3 g/m². The A layer had a weight per unit area of 6.8 g/m². The B layer had a weight per unit area of 6.5 g/m².

### Example 4

Operations similar to those of Example 1 were carried out except that water, resorcin, 37% formalin, and sodium carbonate as a catalyst were mixed with one another so that the molar ratio of the resorcin to formaldehyde in the formalin was 1:1. This produced a filler. The filler produced was a filler 4. The filler 4 was made substantially only of a benzendiol-aldehyde resin. In other words, the filler 4 contained a benzendiol-aldehyde resin in an amount of not less than 98%. The filler 4 had a particle size distribution in which D10 was 0.32 μm, D50 was 0.55 μm, and D90 was 2.58 μm.

A nonaqueous electrolyte secondary battery laminated separator 4 was prepared by a method similar to the method for Example 1 except that the filler 1 was replaced with the filler 4. Then, a nonaqueous electrolyte secondary battery 4 was prepared by a method similar to the method for Example 1 except that the nonaqueous electrolyte secondary battery laminated separator 1 was replaced with the nonaqueous electrolyte secondary battery laminated separator 4.

The nonaqueous electrolyte secondary battery laminated separator 4 had an overall film thickness of 17.9 μm. The A layer had a film thickness of 12.0 μm. The B layer had a film thickness of 5.9 μm. The nonaqueous electrolyte secondary battery laminated separator 4 had an overall weight per unit area of 13.8 g/m². The A layer had a weight per unit area of 6.8 g/m². The B layer had a weight per unit area of 7.0 g/m².

### Comparative Example 1

Commercially available aluminum oxide (available from Sumitomo Chemical Co., Ltd., AKP-3000) as a filler 5, CMC, and a mixed solvent of water and isopropyl alcohol were mixed with one another to prepare a mixed liquid in such a manner that (i) 3 parts by weight of CMC were mixed with 100 parts by weight of the filler, that (ii) the solid-content concentration (that is, the total concentration of the filler and the CMC) was 27.7% by weight, and that (iii) the solvent composition of the above mixed solvent was 95% by weight of water and 5% by weight of isopropyl alcohol. The mixed liquid thus produced was a dispersion liquid of the filler. The dispersion liquid thus obtained was dispersed by high pressure (high-pressure dispersion conditions: 100 MPa×3 passes) with use of a high-pressure dispersing device (available from Sugino Machine Limited; Star Burst), so that a coating solution 5 was prepared.

A nonaqueous electrolyte secondary battery laminated separator 5 was prepared by a method similar to the method for Example 1 except that the coating solution was replaced with the coating solution 5. Then, a nonaqueous electrolyte secondary battery 5 was prepared by a method similar to the method for Example 1 except that the nonaqueous electrolyte secondary battery laminated separator 1 was replaced with the nonaqueous electrolyte secondary battery laminated separator 5.

The filler 5 had a particle size distribution in which D10 was 0.39 μm, D50 was 0.86 μm, and D90 was 2.23 μm. The filler 5 had a crushing strength of 2400 MPa.

The nonaqueous electrolyte secondary battery laminated separator 5 had an overall film thickness of 17.6 μm. The A layer had a film thickness of 12.0 μm. The B layer had a film thickness of 5.6 μm. The nonaqueous electrolyte secondary battery laminated separator 5 had an overall weight per unit area of 13.1 g/m². The A layer had a weight per unit area of 6.8 g/m². The B layer had a weight per unit area of 6.3 g/m².

### Comparative Example 2

A coating solution was prepared by a method similar to the method for Example 1 except that the filler 1 was replaced with a commercially available phenol resin (available from Gun Ei Chemical Industry Co., Ltd.) as a filler 6. The coating solution prepared was a coating solution 6.

A nonaqueous electrolyte secondary battery laminated separator 6 was prepared by a method similar to the method for Example 1 except that the coating solution was replaced with the coating solution 6. Then, a nonaqueous electrolyte secondary battery 6 was prepared by a method similar to the method for Example 1 except that the nonaqueous electrolyte secondary battery laminated separator 1 was replaced with the nonaqueous electrolyte secondary battery laminated separator 6.

The filler 6 had a particle size distribution in which D10 was 6.45 μm, D50 was 8.62 μm, and D90 was 11.51 μm. The filler 6 had a crushing strength of 1400 MPa.

The nonaqueous electrolyte secondary battery laminated separator 6 had an overall film thickness of 28.6 μm. The A layer had a film thickness of 12.0 μm. The B layer had a film thickness of 16.6 μm. The nonaqueous electrolyte secondary battery laminated separator 6 had an overall weight per unit area of 13.3 g/m². The A layer had a weight per unit area of 6.8 g/m². The B layer had a weight per unit area of 6.5 g/m².

[Results]

TABLE 1

| | Capacity maintaining rate |
|---|---|
| | after 100 cycles [%] |
| Example 1 | 90 |
| Example 2 | 90 |
| Example 3 | 92 |
| Example 4 | 89 |
| Comparative | 85 |
| Example 1 | |
| Comparative | 80 |
| Example 2 | |

Table 1 shows that the nonaqueous electrolyte secondary batteries 1 to 4, which were produced respectively in Examples 1 to 4 and each of which included a porous layer containing a filler including a benzendiol-aldehyde resin, each had an excellent long-term cycle characteristic as compared to the nonaqueous electrolyte secondary battery 5, which was produced in Comparative Example 1 and which included a porous layer containing an inorganic filler, or the nonaqueous electrolyte secondary battery 6, which was produced in Comparative Example 2 and which included a porous layer containing a filler including phenol resin.

The results prove that a porous layer in accordance with an embodiment of the present invention which porous layer contains a filler including a benzendiol-aldehyde resin allows a nonaqueous electrolyte secondary battery including the porous layer to have an improved long-term cycle characteristic.

### INDUSTRIAL APPLICABILITY

A nonaqueous electrolyte secondary battery porous layer in accordance with an embodiment of the present invention is usable for production of a nonaqueous electrolyte secondary battery having an excellent long-term cycle characteristic.

1. A nonaqueous electrolyte secondary battery porous layer, comprising:
a filler including a benzendiol-aldehyde resin.

2. The nonaqueous electrolyte secondary battery porous layer according to claim 1, wherein
the filler has a content of not less than 60% by weight and not more than 99.5% by weight with respect to a total weight of the nonaqueous electrolyte secondary battery porous layer.

3. The nonaqueous electrolyte secondary battery porous layer according to claim 1, further comprising:
at least one binder resin selected from the group consisting of a polyolefin, a (meth)acrylate-based resin, a fluorine-containing resin, a polyamide-based resin, a polyester-based resin, and a water-soluble polymer.

4. The nonaqueous electrolyte secondary battery porous layer according to claim 3, wherein
the polyamide-based resin is aramid resin.

5. A nonaqueous electrolyte secondary battery laminated separator, comprising:
a polyolefin porous film; and
a nonaqueous electrolyte secondary battery porous layer according to claim 1,
the nonaqueous electrolyte secondary battery porous layer being provided on at least one surface of the polyolefin porous film.

6. A nonaqueous electrolyte secondary battery member, comprising:
a positive electrode;
a nonaqueous electrolyte secondary battery porous layer according to claim 1; and
a negative electrode,
the positive electrode, the nonaqueous electrolyte secondary battery porous layer, and the negative electrode being arranged in this order.

7. A nonaqueous electrolyte secondary battery, comprising:
a nonaqueous electrolyte secondary battery porous layer according to claim 1.

8. A nonaqueous electrolyte secondary battery member, comprising:
a positive electrode;
a nonaqueous electrolyte secondary battery laminated separator according to claim 5; and
a negative electrode,
the positive electrode, the nonaqueous electrolyte secondary battery laminated separator, and the negative electrode being arranged in this order.

9. A nonaqueous electrolyte secondary battery, comprising:
a nonaqueous electrolyte secondary battery laminated separator according to claim 5.
